(19) United States
(12) Patent Application Publication
(10) Pub. No.: US 2024/0297789 A1
(43) Pub. Date: Sep. 5, 2024

(54) CONSENSUAL THIRD PARTY IDENTIFICATION SYSTEM ARCHITECTURE

(71) Applicant: Secure Identity, LLC, New York, NY (US)

(72) Inventor: Derek Gottfrid, New York, NY (US)

(21) Appl. No.: 18/591,229

(22) Filed: Feb. 29, 2024

Related U.S. Application Data
(60) Provisional application No. 63/449,088, filed on Mar. 1, 2023.

(51) Int. Cl. H04L 9/32

(52) U.S. Cl. CPC H04L 9/3213; H04L 9/3231

(57) ABSTRACT

A consensual third party identification system architecture includes an identification system that may store and/or verify identity information associated with the identities of users. One or more clients may allow users to provide proof of their identities and/or identity information. In order to do so, the client may provide the users one or more login interfaces and/or other user interfaces, which may have been provided to the clients by the identification system and/or may have been generated using information provided by the identification system. The login interfaces may enable the users to log in to the identification system to authorize information stored for the users to be shared with the client. The login interfaces may include information provided by the clients that specify to the identification system as part of the login various data regarding the client.

### CROSS-REFERENCE TO RELATED APPLICATION(S)

This application is a nonprovisional patent application of and claims the benefit of U.S. Provisional Patent Application No. 63/449,088, filed Mar. 1, 2023 and titled “Consensual Third Party Identification System Architecture,” the disclosure of which is hereby incorporated herein by reference in its entirety.

### FIELD

The described embodiments relate generally to identification. More particularly, the present embodiments relate to a consensual third party identification system architecture.

### BACKGROUND

There are many situations where people provide proof of their identity. In some situations, proving their identities may involve verifying that the people are who they assert. In other situations, proving their identities may involve proving information associated with their identities, such as proving their ages, their insurance statuses, and so on. People may prove their identities and/or information associated with their identities using documentary evidence, such as identification cards (such as driver's licenses, federal or state identification cards, passports, learner's permits, and so on), insurance cards, and so on.

Biometric identification systems may identify people using biometrics. Biometrics may include fingerprints, palm prints, irises, eyes, faces, voices, gaits, pictures, or other identifying characteristics about a person. A biometric identification system may capture information about a biometric using a biometric reader and identify a person by comparing the captured information against stored information. For example, an image sensor may capture an image of a fingerprint and compare the image of the fingerprint against stored fingerprint images.

### SUMMARY

The present disclosure relates to a consensual third party identification system architecture. An identification system may store and/or verify identity information associated with the identities of users. One or more clients may allow users to provide proof of their identities and/or identity information. In order to do so, the client may provide the users one or more login interfaces and/or other user interfaces, which may have been provided to the clients by the identification system and/or may have been generated using information provided by the identification system. The login interfaces may enable the users to log in to the identification system (such as via the OpenID connect protocol, another OAuth protocol, and so on) to authorize information stored for the users to be shared with the client. The login interfaces may include information provided by the clients (such as one or more tokens) that specify to the identification system as part of the login various data regarding the client (such as specific data elements to be provided if the user authorizes, requests to indicate if a particular data element satisfies one or more criteria, assurance level requirements, client network addresses to send the information, and so on).

In various embodiments, a consensual third party identification system includes a client device that has a non-transitory storage medium storing instructions and a processor. The processor executes the instructions to provide a login interface for an identification system to a user device, the login interface including information related to a client; receive user information from the identification system, the user information specified in the information; and perform an action using the user information.

In some examples, the login interface is usable by the user to communicate with the identification system via at least one of OpenID Connect or OAuth. In a number of examples, the information is contained in a token.

In various examples, the user information specifies at least one requested data element. In some implementations of such examples, the at least one requested data element includes at least one of a verified age, an insurance status, or a driver's license status.

In a number of examples, the user information specifies an assurance level. In various examples, the login interface includes at least one of a web-based interface, a mobile interface, or a JavaScript client interface.

In some embodiments, a consensual third party identification system includes an identification system device that has a non-transitory storage medium storing instructions and a processor. The processor executes the instructions to receive a login from a user via a login interface provided to the user by a client, retrieve data requested by the client from information related to the client submitted with the login, retrieve corresponding identity data from stored user identity data, and provide the corresponding identity data to the client.

In various examples, the processor provides the login interface to the client. In some implementations of such examples, the login interface includes at least one of a web-based interface, a mobile interface, or a JavaScript client interface.

In a number of examples, the processor retrieves the information related to the client from a token submitted with the login. In various examples, the processor enrolls the user in an identification system by obtaining biographic information for the user, verifying the biographic information, determining an assurance level, and storing the biographic information in the stored user identity data. In a number of examples, the corresponding identity data includes at least one of a verified age, an insurance status, or a driver's license status. In some examples, the corresponding identity data specifies an assurance level.

In a number of embodiments, a consensual third party identification system includes a user device that has a non-transitory storage medium storing instructions and a processor. The processor executes the instructions to use a login interface for an identification system provided by a client to log in to the identification system, provide information related to the client as part of the login, consent to share identity information stored by the identification system with the client, and interact with the client in association with the identity information shared with the client by the identification system.

In some examples, the processor requests the login interface from the client. In various examples, the client is a vehicle rental agency. In a number of examples, the identity information includes payment information. In some examples, the processor uses at least one of OpenID Connect or OAuth to log in to the identification system via the login interface. In various examples, the processor provides at least one digital representation of a biometric to the identification system.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system illustrating a consensual third party identification system architecture.

FIG. 2 is a flow chart illustrating a first example method for using a consensual third party identification system architecture. The method may be performed by the system of FIG. 1.

FIG. 3 is a flow chart illustrating a second example method for using a consensual third party identification system architecture. The method may be performed by the system of FIG. 1.

FIG. 4 is a flow chart illustrating a third example method for using a consensual third party identification system architecture. The method may be performed by the system of FIG. 1.

FIG. 5 is a flow chart illustrating a fourth example method for using a consensual third party identification system architecture. The method may be performed by the system of FIG. 1.

FIG. 6 is a flow chart illustrating a fifth example method for using a consensual third party identification system architecture. The method may be performed by the system of FIG. 1.

FIG. 7 is a flow chart illustrating an example method for enrolling users in a consensual third party identification system architecture. The method may be performed by the system of FIG. 1.

FIG. 8 is a flow chart illustrating a sixth example method for using a consensual third party identification system architecture. The method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

Use of documentary evidence to prove identity and/or information associated with identity may be subject to fraud via forged documentary evidence. People and/or entities relying on documentary evidence may examine the documentary evidence to attempt to detect forgery. However, some forgeries may be more difficult to detect than others, or be more challenging to detect in some situations than others. For example, shifting such operations to the technological environment of network operations (such as where the documentary evidence is submitted from at least one computing device to at least one other computing device via at least one network) may add the technological problem of how to detect fraud when traditional methods of examining the documentary evidence cannot be performed, or performed as thoroughly, given that the documentary evidence is not actually present.

An identification system may be a system that is operable to identify people's identities and/or various information associated with their identities (i.e., identity information). The identification system may collect such information, verify the information, and respond to requests to identify the people and/or provide and/or verify information associated with identities of the people. Identification systems that involve the use of biometrics may be biometric identification systems.

Identification systems may typically be bespoke systems. In some examples, they may be configured for very particular applications in the assurance levels required for identity information. For example, a first assurance level may specify that a person has a phone number registered to a name that corresponds to the name that they provided. A second, higher assurance level may specify that the person have a driver's license or other identification card that includes an image of at least a face that matches an image of at least a face that the person provided. A third, still higher assurance level may specify that the person be subjected to iris or retinal matching. A fourth, yet higher assurance level may specify that the person provide biometrics and/or a driver's license or other documentary evidence for verification during live monitoring by an agent. Regardless, an identification system that stores identity information that satisfies a particular assurance level may not be usable by requesting clients that require a different assurance level.

Further, identification systems may be configured with very particular interfaces in how clients may request information, the information that may be requested, how requested information is returned, and so on. Clients may be required to be aware of all of the particularities of the interface and be configured accordingly in order to use the identification system, which may be burdensome on the client and may not support all of the client's requirements. Alternatively, new identification systems may be generated for the needs of individual clients, which may involve a great deal of duplication of hardware, software, and/or other resources.

The present disclosure relates to a consensual third party identification system architecture. An identification system may store and/or verify identity information associated with the identities of users. One or more clients may allow users to provide proof of their identities and/or identity information. In order to do so, the client may provide the users one or more login interfaces and/or other user interfaces, which may have been provided to the clients by the identification system and/or may have been generated using information provided by the identification system. The login interfaces may enable the users to log in to the identification system (such as via the OpenID connect protocol, another OAuth protocol, and so on) to authorize information stored for the users to be shared with the client. The login interfaces may include information provided by the clients (such as one or more tokens) that specify to the identification system as part of the login various data regarding the client (such as specific data elements to be provided if the user authorizes, requests to indicate if a particular data element satisfies one or more criteria, assurance level requirements, client network addresses to send the information, and so on).

By way of example, a vehicle rental agency may prompt a user to scan a QR (quick response) code with the user's mobile device. The QR code may cause the person's mobile device to generate a login interface for an identification system where the user is registered. When the user uses the login interface to log in to the identification system, the login interface may pass a token along with the login information. In response to the token, the identification system may prompt the person to share their name, address, telephone number, payment information (such as a credit or debit card number, a checking or savings account number, and so on), whether or not the person is at least 21, whether not the person has valid driving insurance, and so on with the vehicle rental agency. The vehicle rental agency may then determine whether or not to rent the person a vehicle.

In another example, the vehicle rental agency may provide the login interface via a web page in response to a request received from the user via the vehicle rental agency's web site. Various configurations are possible and contemplated without departing from the scope of the present disclosure.

In this way, clients with a variety of different requirements may all use the same identification system without having to conform to the exact same interface. This may allow for performance of functions that were previously not performable and enable more efficient operation while expending less work, eliminating unnecessary hardware and/or other components, more efficiently using hardware, software, network, and/or other resources, and so on. This may improve the operation of systems involved by reducing unnecessary components, increasing the speed at which the systems perform operations, and/or reducing consumption of hardware, software, network, and/or other resources. As such, this consensual third party identification system architecture may provide a technical solution to the technical problem of how to enable clients with different requirements to use the same identification system without having to conform to the exact same interface.

Additionally, this consensual third party identification system architecture may provide a technical solution to the technical problem of how to combat fraud when shifting to a computing device/network environment prevents the user of or reduces the effectiveness of documentary evidence examination and/or other traditional fraud combatting techniques. Various configurations are possible and contemplated without departing from the scope of the present disclosure.

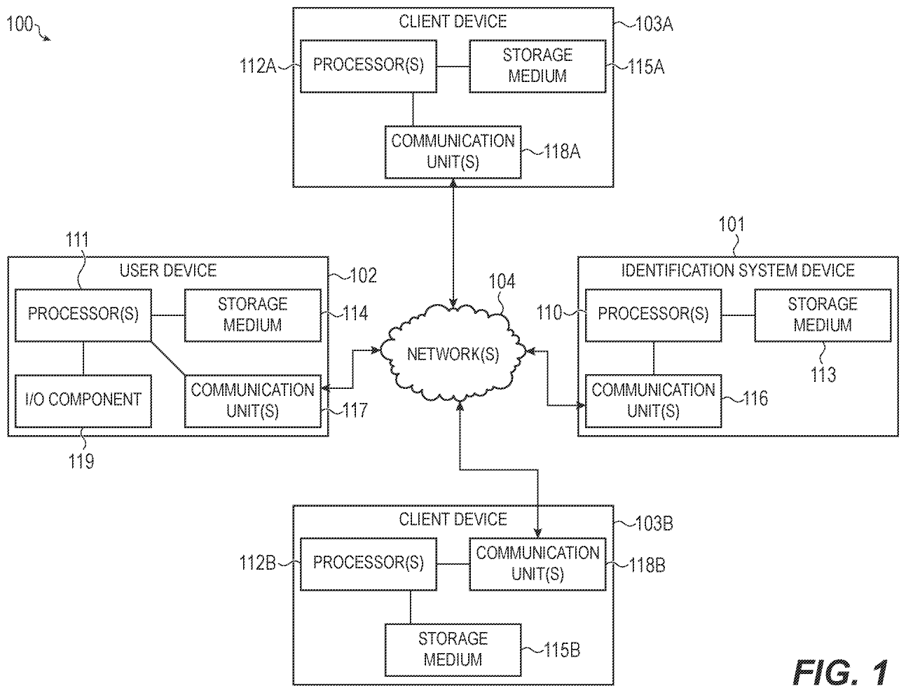

These and other embodiments are discussed below with reference to FIGS. 1-8. However, those skilled in the art will readily appreciate that the detailed description given herein with respect to these Figures is for explanatory purposes only and should not be construed as limiting.

FIG. 1 depicts an example system 100 illustrating a consensual third party identification system architecture. The system 100 may include one or more identification system devices 101, one or more client devices 103A, 103B, and/or one or more user devices 102 that are operable to communicate via one or more wired and/or wireless communication networks 104.

The identification system device 101 may store and/or verify identity information associated with the identities of users. The client devices 103A, 103B may allow users via the user device 102 to provide proof of their identities and/or identity information. In order to do so, the client devices 103A, 103B may provide the users one or more login interfaces and/or other user interfaces, which may have been provided to the client devices 103A, 103B by the identification system device 101 and/or may have been generated using information provided by the identification system device 101. The login interfaces may enable the users to log in to the identification system device 101 (such as via the OpenID connect protocol, another OAuth protocol, and so on) to authorize information stored for the users to be shared with the client. The login interfaces may include information provided by the client devices 103A, 103B (such as one or more tokens) that specify to the identification system device 101 as part of the login various data regarding the client devices 103A, 103B (such as specific data elements to be provided if the user authorizes, requests to indicate if a particular data element satisfies one or more criteria, assurance level requirements, client network addresses to send the information, and so on).

In some examples, the login interface may be a web-based interface. In other examples, the login interface may be a mobile interface. In yet other examples, the login interface may be a Java interface and/or a JavaScript client interface. Various configurations are possible and contemplated without departing from the scope of the present disclosure.

By way of example, a vehicle rental agency may prompt a user to scan a QR (quick response) code with the user's mobile device. The QR code may cause the person's mobile device to generate a login interface for an identification system where the user is registered. When the user uses the login interface to log in to the identification system, the login interface may pass a token along with the login information. In response to the token, the identification system may prompt the person to share their name, address, telephone number, payment information (such as a credit or debit card number, a checking or savings account number, and so on), whether or not the person is at least 21, whether or not the person has valid driving insurance, and so on with the vehicle rental agency. The vehicle rental agency may then determine whether or not to rent the person a vehicle.

In another example, the vehicle rental agency may provide the login interface via a web page in response to a request received from the user via the vehicle rental agency's web site. Various configurations are possible and contemplated without departing from the scope of the present disclosure.

In this way, client devices 103A, 103B with a variety of different requirements may all use the same identification system device 101 without having to conform to the exact same interface. This may allow for performance of functions that were previously not performable and enable more efficient operation while expending less work, eliminating unnecessary hardware and/or other components, more efficiently using hardware, software, network, and/or other resources, and so on. This may improve the operation of systems involved by reducing unnecessary components, increasing the speed at which the systems perform operations, and/or reducing consumption of hardware, software, network, and/or other resources. As such, this consensual third party identification system architecture may provide a technical solution to the technical problem of how to enable client devices 103A, 103B with different requirements to use the same identification system device 101 without having to conform to the exact same interface.

The identification system device 101 may store and/or verify identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like, and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The identification system device 101 may control access to the identity information and/or the health information using identification information that is associated with the identity information. The identification information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identification system device 101 may allow the person associated with an identity to control access to the identity information, the health information, and/or other information (such as payment account information, health information (such as medical records, HIPAA protected information in order to be compliant with various legal restrictions, and so on), contact information, and so on). The identification system device 101 may control access to such information according to input received from the person. The identification system device 101 may be operable to communicate with a station in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The identification system device 101 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The identification system device 101 may include one or more processors 110 and/or other processing units or controllers, communication units 116 (such as one or more network adapters and/or other devices used by a device to communicate with one or more other devices), non-transitory storage media 113, and/or other components. The processor 110 may execute one or more sets of instructions stored in the non-transitory storage media 113 to perform various functions, such as receiving and/or storing biometric data and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, communicating via the network 104 using the communication unit 116, and so on. Alternatively and/or additionally, the identification system device 101 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on.

Similarly, the user device 102 may be any kind of device. The user device 102 may include one or more processors 111 and/or other processing units and/or controllers, one or more non-transitory storage media 114 (which may take the form of, but is not limited to, a magnetic storage medium; optical storage medium; magneto-optical storage medium; read only memory; random access memory; erasable programmable memory; flash memory; and so on), one or more communication units 117, one or more input/output components 119 (such as one or more displays, speakers, microphones, touch screens, keyboards, printers, computer mice, and so on), one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, breath sensor, a deoxyribonucleic acid sensor, a heart rhythm monitor, a microphone, sweat sensors, and so on), one or more biometric readers (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), and/or one or more other components. The processor 111 may execute one or more sets of instructions stored in the non-transitory storage media 114 to perform various functions, such as using the biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtaining health information for a person using the health sensor, communicating with the identification system device 101 via the network 104 using the communication unit 117, and so on.

Likewise, the client device 103A, 103B may be any kind of device. The device 103A, 103B may include one or more processors 112A, 112B and/or other processing units and/or controllers, one or more non-transitory storage media 115A, 115B (which may take the form of, but is not limited to, a magnetic storage medium; optical storage medium; magneto-optical storage medium; read only memory; random access memory; erasable programmable memory; flash memory; and so on), one or more communication units 118A, 118B, and/or one or more other components. The processor 112A, 112B may execute one or more sets of instructions stored in the non-transitory storage media 115A, 115B to perform various functions, such as communicating with the identification system device 101 and/or the user device 102 via the network 104 using the communication unit 118A, 118B, performing one or more actions using received identity information, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

It is understood that FIG. 1 is an example. In other implementations, other configurations of the same, similar, and/or different components may be used without departing from the scope of the present disclosure.

For example, FIG. 1 illustrates two client devices 103A, 103B. However, it is understood that this is an example. In other implementations, other numbers of client devices 103A, 103B, such as one or ten, may be used without departing from the scope of the present disclosure. Various configurations are possible and contemplated.

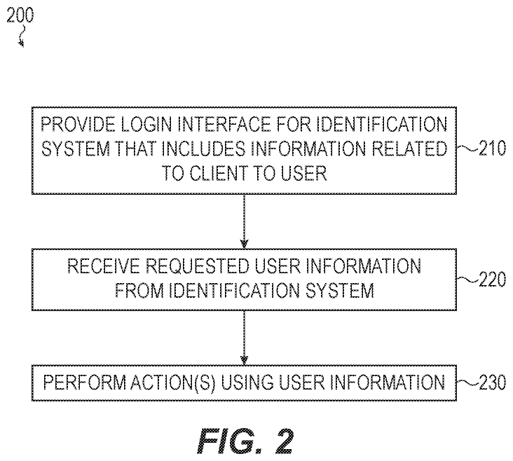

FIG. 2 is a flow chart illustrating a first example method 200 for using a consensual third party identification system architecture. The method 200 may be performed by the system 100 of FIG. 1.

At operation 210, an electronic device (such as one or more of the client devices 103A, 103B of FIG. 1) may provide a login interface for an identification system that includes information related to a client to a user. For example, the login interface may include a token specifying the information. The login interface may be configured to submit the token to the identification system as part of logging into the identification system. The login interface may be usable by the user to login to the identification system via a protocol like the OpenID connect protocol, another OAuth protocol, and so on.

At operation 220, the electronic device may receive requested user information from identification system. The user information may include a name, address, telephone number, payment information, verified age, verified insurance status, a driver's license status, and/or any other information about the user. The user information may have been authorized to be shared with the client by the user upon login to the identification system.

At operation 230, the electronic device may perform one or more actions using the user information. Such actions may include processing a payment, determining whether or not the user is of a minimum age, and so on.

By way of example, an online wine merchant may be required by law to verify that purchasers are at least 21 years of age. The online wine merchant may receive a purchase request via their web site. The online wine merchant may direct the purchaser to a login interface page where the purchaser may log in to an identification system. Login may pass information from the online wine merchant to the identification system that the online wine merchant requests verification that the purchaser is at least 21 years of age. The identification system may prompt the purchaser to authorize sharing of that information and upon authorization may notify the online wine merchant, who may complete the purchase if the response is affirmative. Various configurations are possible and contemplated without departing from the scope of the present disclosure.

In various examples, this example method 200 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the operation 220 illustrates and describes the requested user information being received from the identification system. However it is understood that this is an example. In various implementations, the requested user information may be received via another device, such as a user device, that communicates with the identification system. Various configurations are possible and contemplated without departing from the scope of the present disclosure.

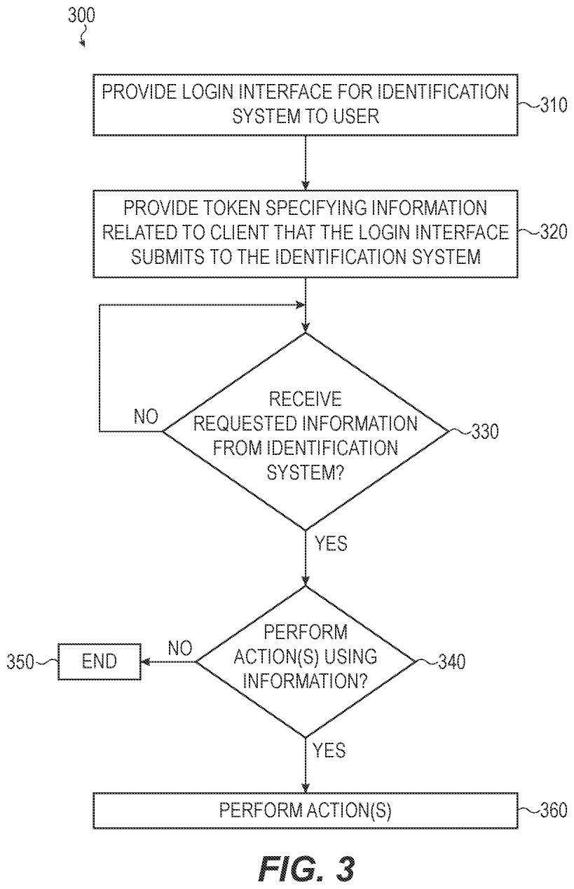

FIG. 3 is a flow chart illustrating a second example method 300 for using a consensual third party identification system architecture. The method 300 may be performed by the system 100 of FIG. 1.

At operation 310, an electronic device (such as one or more of the client devices 103A, 103B of FIG. 1) may provide a login interface for an identification system to a user. The electronic device may provide the login interface to the user in response to receiving a request from the user. The login interface may be usable by the user to login to the identification system via a protocol like the OpenID connect protocol, another OAuth protocol, and so on.

At operation 320, the electronic device may provide a token specifying information related to the client that the login interface submits to the identification system. The login interface may submit the token to the identification system as part of a login process initiated using the login interface. The token may specify information that is requested by the electronic device.

At operation 330, the electronic device may determine whether or not requested information is received from the identification system. If not, the flow may return to operation 330 where the electronic device may again determine whether or not requested information is received from identification system. Otherwise, the flow may proceed to operation 340.

At operation 340, the electronic device may determine whether or not to perform one or more actions using the information. If not, the flow may proceed to operation 350 and end. Otherwise, the flow may proceed to operation 360 where the electronic device may perform the one or more actions.

For example, the electronic device may be configured to provide an electronic ballot to a user upon confirming the user's name and address. If the received information confirms the user's name and address, the flow may proceed to operation 360 where the electronic device may provide the user the electronic ballot. Otherwise, the flow may proceed to operation 350 and end.

In various examples, this example method 300 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as determining whether or not to perform the one or more actions. However, it is understood that this is an example. In some implementations, the electronic device may perform the one or more actions upon receiving the requested information without a separate determination of whether or not to do so. Various configurations are possible and contemplated without departing from the scope of the present disclosure.

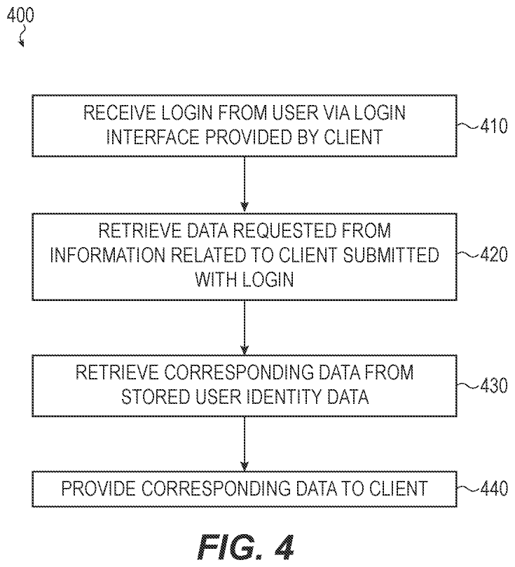

FIG. 4 is a flow chart illustrating a third example method 400 for using a consensual third party identification system architecture. The method 400 may be performed by the system 100 of FIG. 1.

At operation 410, an electronic device (such as the identification system device 101 of FIG. 100) may receive a login from user via a login interface provided by a client. The login interface may use a protocol like the OpenID connect protocol, another OAuth protocol, and so on. The login may be associated with information related to the client submitted with the login. For example, the information may be included in a token included with the login, stored in a data store associated with an identifier included in the token (such as in implementations where the data store includes a configuration file of different response configurations that may be specified in identifiers included in tokens), and so on.

At operation 420, the electronic device may retrieve data requested from the information related to the client submitted with the login. For example, the information may request payment information for a user and the electronic device may retrieve the request for payment information from the information related to the client submitted with the login. By way of illustration, the request may be in a token and the electronic device may receive the request from the token.

At operation 430, the electronic device may retrieve corresponding data from stored user identity data. For example, the electronic device may retrieve the requested payment information from stored user identity data.

At operation 440, the electronic device may provide corresponding data to the client. For example the electronic device may provide the requested payment information that was retrieved from stored user identity data to the client.

In various examples, this example method 400 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrates operations 420 and 430 as separate, linearly performed operations. However, it is understood that this is an example. In some implementations, these operations may be combined into a single operation, be performed in a different order, and so on. Various configurations are possible and contemplated without departing from the scope of the present disclosure.

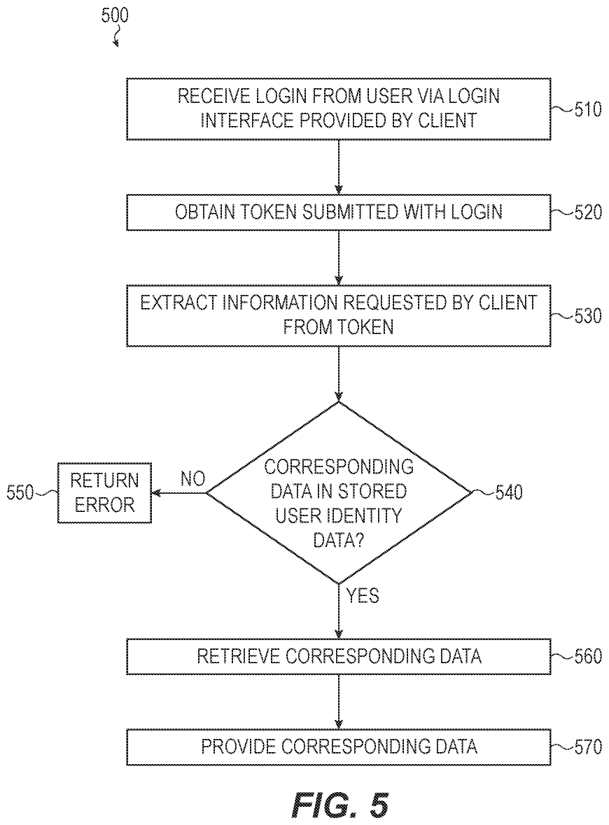

FIG. 5 is a flow chart illustrating a fourth example method 500 for using a consensual third party identification system architecture. The method 500 may be performed by the system 100 of FIG. 1.

At operation 510, an electronic device (such as the identification system device 101 of FIG. 100) may receive a login from a user via a login interface provided by a client. The login interface may use a protocol like the OpenID connect protocol, another OAuth protocol, and so on. At operation 520, the electronic device may obtain a token submitted with the login. At operation 530, the electronic device may extract information requested by the client from the token.

At operation 540, the electronic device may determine whether or not corresponding data responsive to the information requested by the client is in stored user identity data. If not, the flow may proceed to operation 550 where the electronic device may return an error. Otherwise, the flow may proceed to operation 560

At operation 560, the electronic device may retrieve the corresponding data. The flow may then proceed to operation 570 where the electronic device may provide the retrieved corresponding data.

In various examples, this example method 500 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as determining whether or not the corresponding data can be retrieved. However, it is understood that this is an example. In some implementations, the electronic device may retrieve and provide whatever corresponding data is stored without determining whether not the corresponding data can be retrieved. Various configurations are possible and contemplated without departing from the scope of the present disclosure.

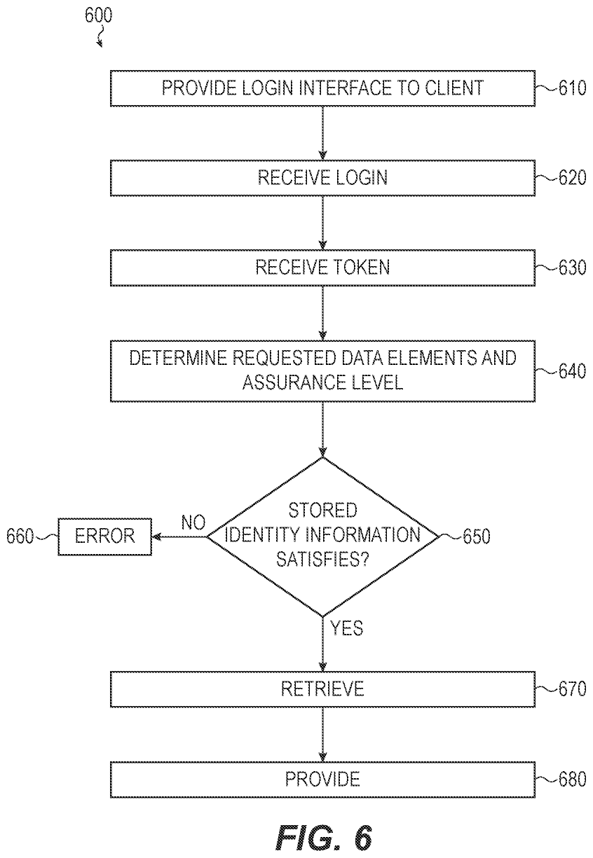

FIG. 6 is a flow chart illustrating a fifth example method 600 for using a consensual third party identification system architecture. The method 600 may be performed by the system 100 of FIG. 1.

At operation 610, an electronic device (such as the identification system device 101 of FIG. 100) may provide a login interface to a client. Alternatively, the electronic device may provide information to the client that the client may use to generate the login interface.

At operation 620, the electronic device may receive a login via the login interface. The login interface may use a protocol like the OpenID connect protocol, another OAuth protocol, and so on. At operation 630, the electronic device may receive a token in association with the login. At operation 640, the electronic device may determine requested data elements and one or more assurance levels specified in association with the token.

At operation 650, the electronic device may determine whether or not stored identity information satisfies the requested data elements and one or more assurance levels. If not, the flow may proceed to operation 660 where the electronic device may return an error. Otherwise, the flow may proceed to operation 670.

At operation 670, the electronic device may retrieve the stored identity information that satisfies the requested data elements and one or more assurance levels. The flow may then proceed to operation 680 where the electronic device may provide the retrieved stored identity information that satisfies the requested data elements and one or more assurance levels.

In various examples, this example method 600 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method is illustrated and described as using a token. However, it is understood that this is an example. In various implementations, information associated with the requested data elements and one more assurance levels may be obtained from a source other than a token. Various configurations are possible and contemplated without departing from the scope of the present disclosure.

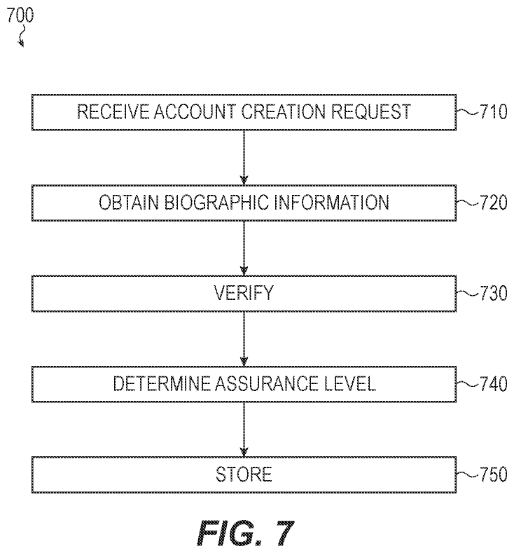

FIG. 7 is a flow chart illustrating an example method 700 for enrolling users in a consensual third party identification system architecture. The method 700 may be performed by the system 100 of FIG. 1.

At operation 710, an electronic device (such as the identification system device 101 of FIG. 100) may receive an account creation request. The account creation request may be from a user to create an account in an identification system.

At operation 720, the electronic device may obtain biographic information. The biographic information may include information such as one or more names, phone numbers, addresses, ages, identification card numbers, and so on.

At operation 730, the electronic device may verify information for the account. The information that is verified may be the biographic information. For example, the electronic device may verify that the user's name is the one provided, that the user's address is correct, that the phone number is registered to the user, that the user is the age the user claims to be (such as using an identification card issued to the user that specifies the user's age), that the user is who the user asserts to be (which may involve biometric information, which may also be stored with the account.

At operation 740, the electronic device may determine one or more assurance levels. For example, the electronic device may determine an assurance level to which the information associated with the user has been verified. Alternatively, the assurance level may be the highest level to which information associated with the user has been verified.

At operation 750, the electronic device may store the information in association with the account. The information may include the biographic information, biometric information, which stored information has been verified, and assurance level associated with one or more pieces of the stored information, and so on.

In various examples, this example method 700 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

In some implementations, the method 700 may be used to enroll the user in an identification system. However, it is understood that this is an example. In other implementations, the method 700 may be used for other purposes. Various configurations are possible and contemplated without departing from the scope of the present disclosure.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 may include one more additional operations. Such operations may include receiving a request for information stored for the user, receiving requests regarding whether or not information stored for the user meets one or more criteria, providing a login interface and/or information usable to generate a login interface, receiving a login from the user, providing information regarding the user, determining whether or not the user has authorized sharing of information stored for the user, identifying the user, and so on. Various configurations are possible and contemplated without departing from the scope of the present disclosure.

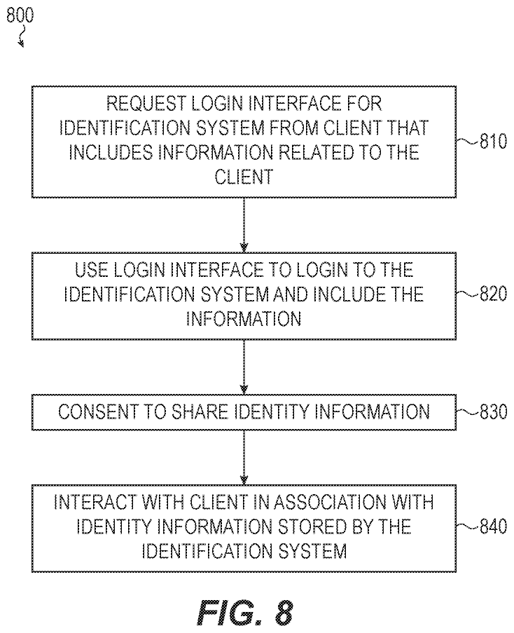

FIG. 8 is a flow chart illustrating a sixth example method 800 for using a consensual third party identification system architecture. The method 800 may be performed by the system 100 of FIG. 1.

At operation 810, an electronic device (such as the user device 102 of FIG. 1) may request a login interface for an identification system from a client that includes information related to the client. The electronic device may request the login interface in response to a request received from a user.

At operation 820, the electronic device may use the login interface to log in to the identification system and include the information. The electronic device may use the login interface in response to a request received from the user. The login interface may use a protocol like the OpenID connect protocol, another OAuth protocol, and so on.

At operation 830, the electronic device may consent to share identity information. The electronic device may consent to share the identity information with the client. The electronic device may use the consent to share the identity information in response to a request received from the user.

At operation 840, the electronic device may interact with the client in association with the identity information stored by the identification system. For example, the client may be engaged in an interaction with the client associated with a commercial transaction that the client will perform dependent upon the identity information stored by the identification system. After the identity information is shared with the client upon consent being provided by the electronic device, the electronic device and the client may then complete the commercial transaction. Various configurations are possible and contemplated without departing from the scope of the present disclosure.

In various examples, this example method 800 may be implemented using a group of interrelated software modules or components that perform various functions discussed herein. These software modules or components may be executed within a cloud network and/or by one or more computing devices, such as the identification system device 101, the user device 102 and/or one or more of the client devices 103A, 103B of FIG. 1.

Although the example method 800 is illustrated and described as including particular operations performed in a particular order, it is understood that this is an example. In various implementations, various orders of the same, similar, and/or different operations may be performed without departing from the scope of the present disclosure.

For example, the method includes operation 840. However, it is understood that this is an example. In various implementations, operation 840 may be omitted. Various configurations are possible and contemplated without departing from the scope of the present disclosure.

In various implementations, a consensual third party identification system may include a client device that has a non-transitory storage medium storing instructions and a processor. The processor may execute the instructions to provide a login interface for an identification system to a user device, the login interface including information related to a client; receive user information from the identification system, the user information specified in the information; and perform an action using the user information.

In some examples, the login interface may be usable by the user to communicate with the identification system via at least one of OpenID Connect or OAuth. In a number of examples, the information may be contained in a token.

In various examples, the user information may specify at least one requested data element. In some such examples, the at least one requested data element may include at least one of a verified age, an insurance status, or a driver's license status.

In a number of examples, the user information may specify an assurance level. In various examples, the login interface may include at least one of a web-based interface, a mobile interface, or a JavaScript client interface.

In some implementations, a consensual third party identification system may include an identification system device that has a non-transitory storage medium storing instructions and a processor. The processor may execute the instructions to receive a login from a user via a login interface provided to the user by a client, retrieve data requested by the client from information related to the client submitted with the login, retrieve corresponding identity data from stored user identity data, and provide the corresponding identity data to the client.

In various examples, the processor may provide the login interface to the client. In some such examples, the login interface may include at least one of a web-based interface, a mobile interface, or a JavaScript client interface.

In a number of examples, the processor may retrieve the information related to the client from a token submitted with the login. In various examples, the processor may enroll the user in an identification system by obtaining biographic information for the user, verifying the biographic information, determining an assurance level, and storing the biographic information in the stored user identity data. In a number of examples, the corresponding identity data may include at least one of a verified age, an insurance status, or a driver's license status. In some examples, the corresponding identity data specifies an assurance level.

In a number of implementations, a consensual third party identification system may include a user device that has a non-transitory storage medium storing instructions and a processor. The processor may execute the instructions to use a login interface for an identification system provided by a client to log in to the identification system, provide information related to the client as part of the login, consent to share identity information stored by the identification system with the client, and interact with the client in association with the identity information shared with the client by the identification system.

In some examples, the processor may request the login interface from the client. In various examples, the client may be a vehicle rental agency. In a number of examples, the identity information may include payment information. In some examples, the processor may use at least one of OpenID Connect or OAuth to log in to the identification system via the login interface. In various examples, the processor may provide at least one digital representation of a biometric to the identification system.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to a consensual third party identification system architecture. An identification system may store and/or verify identity information associated with the identities of users. One or more clients may allow users to provide proof of their identities and/or identity information. In order to do so, the client may provide the users one or more login interfaces and/or other user interfaces, which may have been provided to the clients by the identification system and/or may have been generated using information provided by the identification system. The login interfaces may enable the users to log in to the identification system (such as via the OpenID connect protocol, another OAuth protocol, and so on) to authorize information stored for the users to be shared with the client. The login interfaces may include information provided by the clients (such as one or more tokens) that specify to the identification system as part of the login various data regarding the client (such as specific data elements to be provided if the user authorizes, requests to indicate if a particular data element satisfies one or more criteria, assurance level requirements, client network addresses to send the information, and so on).

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A consensual third party identification system, comprising:
a client device, comprising:
a non-transitory storage medium storing instructions; and
a processor that executes the instructions to:
provide a login interface for an identification system to a user device, the login interface including information related to a client;
receive user information from the identification system, the user information specified in the information; and
perform an action using the user information.

2. The system of claim 1, wherein the login interface is usable by the user to communicate with the identification system via at least one of OpenID Connect or OAuth.

3. The system of claim 1, wherein the information is contained in a token.

4. The system of claim 1, wherein the user information specifies at least one requested data element.

5. The system of claim 4, wherein the at least one requested data element includes at least one of a verified age, an insurance status, or a driver's license status.

6. The system of claim 1, wherein the user information specifies an assurance level.

7. The system of claim 1, wherein the login interface comprises at least one of a web-based interface, a mobile interface, or a JavaScript client interface.

8. A consensual third party identification system, comprising:
an identification system device, comprising:
a non-transitory storage medium storing instructions; and
a processor that executes the instructions to:
receive a login from a user via a login interface provided to the user by a client;
retrieve data requested by the client from information related to the client submitted with the login;
retrieve corresponding identity data from stored user identity data; and
provide the corresponding identity data to the client.

9. The system of claim 8, wherein the processor provides the login interface to the client.

10. The system of claim 9, wherein the login interface comprises at least one of a web-based interface, a mobile interface, or a JavaScript client interface.

11. The system of claim 8, wherein the processor retrieves the information related to the client from a token submitted with the login.

12. The system of claim 8, wherein the processor enrolls the user in an identification system by:
obtaining biographic information for the user;
verifying the biographic information;
determining an assurance level; and
storing the biographic information in the stored user identity data.

13. The system of claim 8, wherein the corresponding identity data includes at least one of a verified age, an insurance status, or a driver's license status.

14. The system of claim 8, wherein the corresponding identity data specifies an assurance level.

15. A consensual third party identification system, comprising:
a user device, comprising:
a non-transitory storage medium storing instructions; and
a processor that executes the instructions to:
use a login interface for an identification system provided by a client to log in to the identification system;
provide information related to the client as part of the login;
consent to share identity information stored by the identification system with the client; and
interact with the client in association with the identity information shared with the client by the identification system.

16. The system of claim 15, wherein the processor requests the login interface from the client.

17. The system of claim 15, wherein the client comprises a vehicle rental agency.

18. The system of claim 15, wherein the identity information includes payment information.

19. The system of claim 15, wherein the processor uses at least one of OpenID Connect or OAuth to log in to the identification system via the login interface.

20. The system of claim 15, wherein the processor provides at least one digital representation of a biometric to the identification system.
